(19) United States
(12) Patent Application Publication
(10) Pub. No.: US 2015/0122078 A1
(43) Pub. Date: May 7, 2015

(54) BICYCLE PEDAL AND METHOD OF MAKING THE SAME

(71) Applicant: Chung-I Chen, Taichung City (TW)

(72) Inventor: Chung-I Chen, Taichung City (TW)

(21) Appl. No.: 14/595,173

(22) Filed: Jan. 12, 2015

Related U.S. Application Data
(63) Continuation-in-part of application No. 13/792,210, filed on Mar. 11, 2013.

(51) Int. Cl. B62M 3/08

(52) U.S. Cl. CPC B62M 3/08
USPC 74/594.4

(57) ABSTRACT

A bicycle pedal includes a pedal body, a spindle and a bushing The pedal body defines an axle hole therein with opposite first and second openings. The spindle is formed in one piece and has an insert portion generally passing through the axle hole of the pedal body, and a threaded portion extending outside the second opening of the pedal body for being secured to a crane arm of a bicycle. The insert portion has a distal end extending outside the first opening and being shaped to include at least one raised bump on a periphery thereof. The bushing is mounted around the insert portion of the spindle and proximate to the first opening of the pedal body. The distal end of the insert portion of the spindle has a diameter through its raised bump greater than an inner diameter of the bushing so as to retain the spindle in position.

### CROSS-REFERENCE TO RELATED APPLICATION

This is a continuation-in-part of both a co-pending application Ser. No. 13/792,210, filed on Mar. 11, 2013.

### BACKGROUND OF THE INVENTION

1. Field of the Invention

The present invention relates to a bicycle pedal, and more particularly to a bicycle pedal which can be made in a cost-efficient manner.

2. Description of Related Art

Referring to FIG. 7, a conventional bicycle pedal 900 comprises a pedal body 90 and a spindle 91. The pedal body 90 is rotatably mounted about the spindle 91. As best seen in FIG. 8, the spindle 91 has one end formed with a threaded portion 912 to be engaged with a crank arm of a bicycle (not shown), and defines a threaded hole 910 in the other end to engage with a bolt 92. As such, the spindle 91 can be retained in position from displacement with respect to the pedal body 90. However, forming of the threaded hole 910 in the spindle 91 can be troublesome. The manufacturer will have to apply a hole drilling process and a hole threading process to the spindle 91. Moreover, when the threaded hole 910 is made, the bolt 92 will be needed to be coupled to the threaded hole 910 of the spindle 91 for securely retaining the spindle 91 in position. Thus, with all these processes and components, the bicycle pedal 900 cannot be produced at relatively low cost.

### SUMMARY OF THE INVENTION

Accordingly, it is an objective of the present invention is to provide a bicycle pedal that can be produced in a cost-efficient manner.

To achieve the objective, the bicycle pedal generally comprises a pedal body and a spindle. The pedal body defines an axle hole therein with opposite first and second openings. The spindle is formed in one piece and has an insert portion generally and a threaded portion. The insert portion passes through the axle hole of the pedal body. The threaded portion extends outside the second opening of the pedal body for being secured to a crane arm of a bicycle. The first bushing is mounted around the insert portion of the spindle and proximate to the first opening of the pedal body. Moreover, the insert portion has a distal end extending outside the first opening The distal end is shaped to include at least one raised bump on a periphery thereof. More specifically, the distal end of the insert portion of the spindle has a diameter extending through the raised bump greater than an inner diameter of the first bushing so as to retain the spindle in position when the threaded portion is engaged with the crane arm.

Preferably, a washer may be employed and mounted around the insert portion of the spindle and interposed in between the first bushing and the raised bump formed at the distal end of the insert portion.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a bicycle pedal in accordance with the preferred embodiment of the present invention;

FIG. 2 is another perspective view of the bicycle pedal shown in FIG. 1, partially exploded to show the detail;

FIG. 3 is a partial enlarged view of FIG. 2;

FIG. 4 is a cross-sectional view taken along the line IV-IV of FIG. 1;

FIG. 5 is a perspective view of an unfinished, raw pedal used for making the bicycle pedal of FIG. 1;

FIG. 6 is an exploded perspective view of the raw pedal in FIG. 5;

FIG. 7 is a perspective view of a prior art bicycle pedal; and

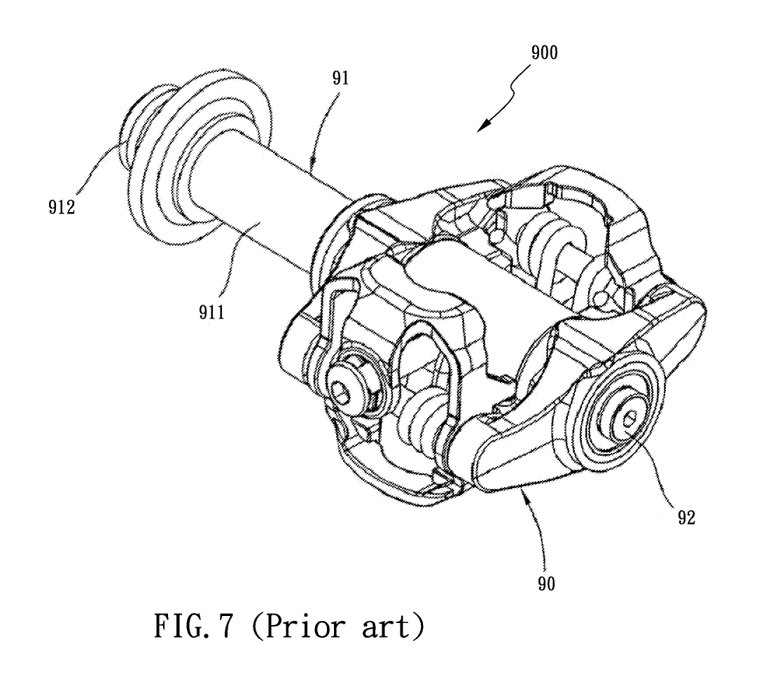

FIG. 8 is an exploded view of the prior art bicycle pedal in FIG. 7.

### DETAILED DESCRIPTION OF THE INVENTION

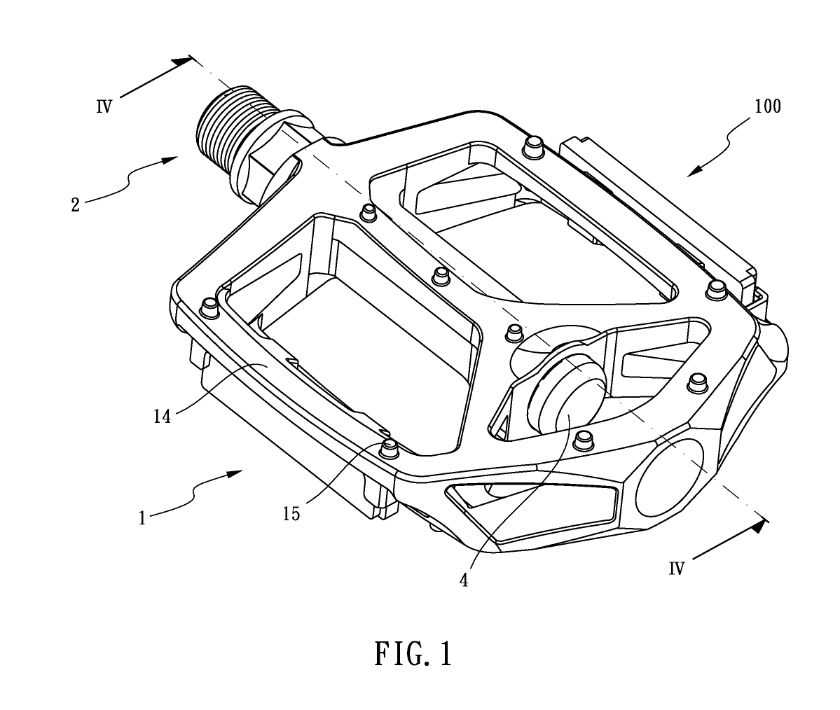

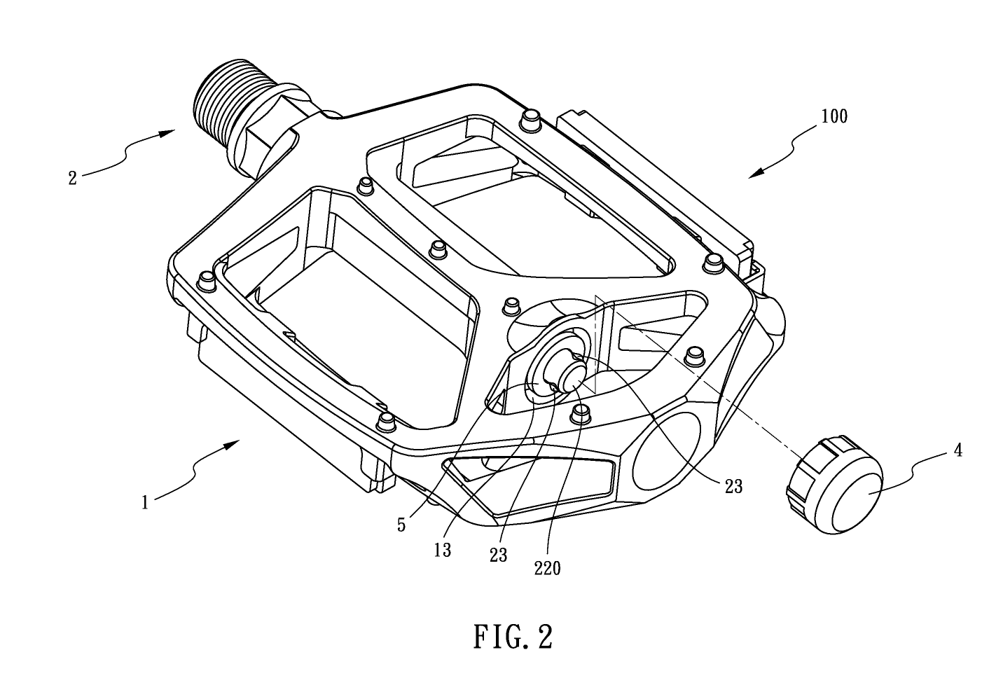

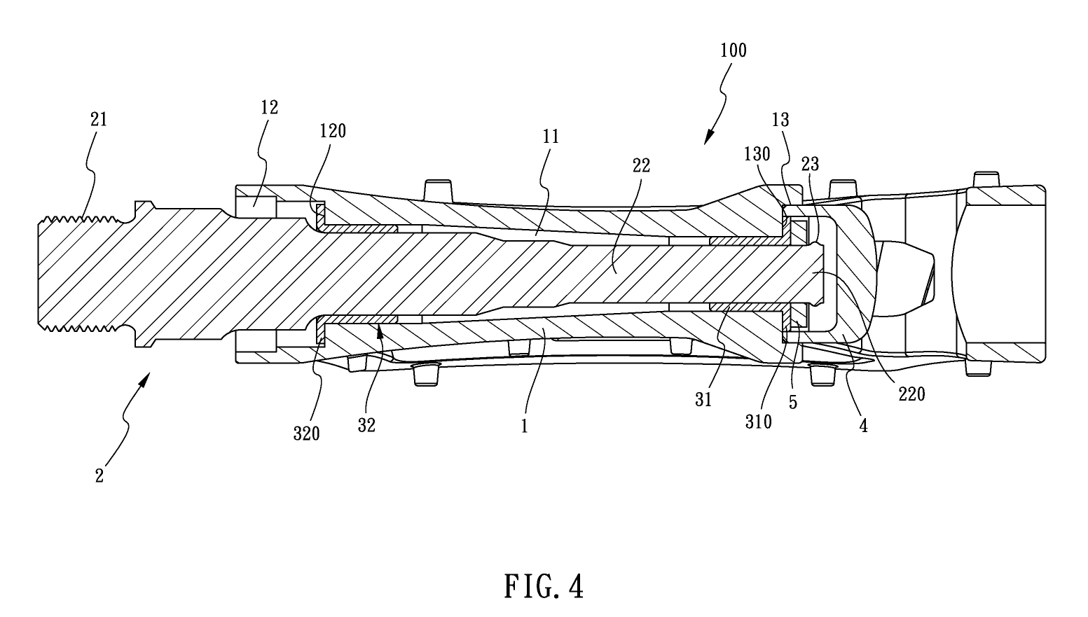

Referring to FIGS. 1-4, there is shown a bicycle pedal 100 in accordance with the preferred embodiment of the present invention. The bicycle pedal 100, such as a BMX pedal, generally includes a pedal body 1, a spindle 2 inserted in an axle hole 11 (FIG. 4) of the pedal body 1, a first bushing 31, a second bushing 32, a washer 5 and a cap 4. In addition, the pedal body 1 further has two opposite treading faces 14 defined thereon and a plurality of skidproof members 15 provided on the two treading faces 14.

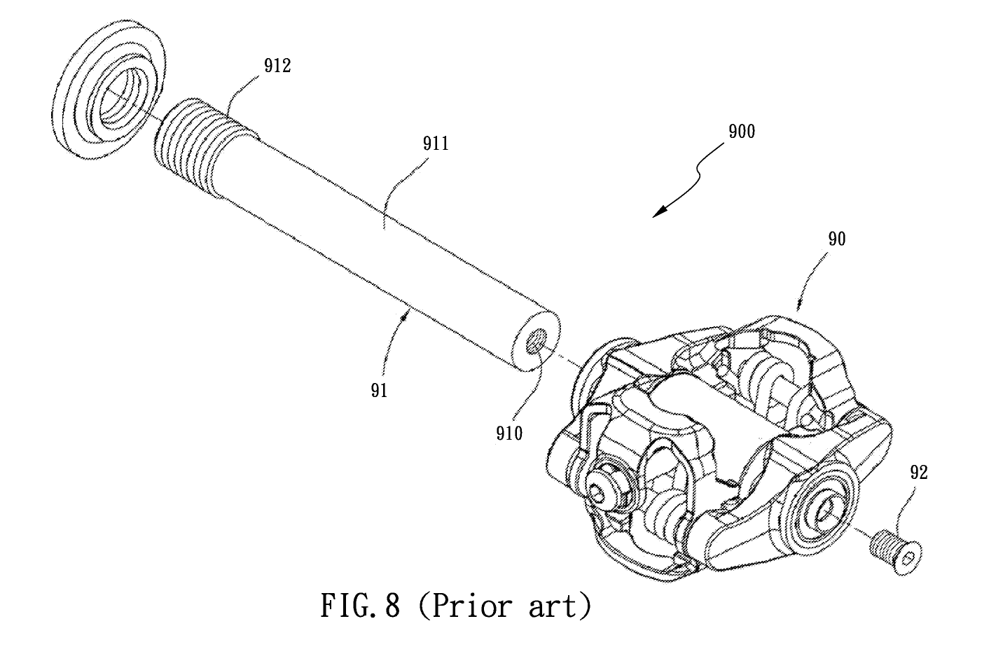

As shown in FIG. 4, the axle hole 11 of the pedal body 1 extends through the pedal body 1 and has a first, stepped opening 13 and a second, stepped opening 12 opposite to the first stepped opening 13. The spindle 2 has an insert portion 22 generally passing through the axle hole 11 of the pedal body 1, and a threaded portion 21 extending outside the second opening 12 of the pedal body 1 for being secured to a crane arm of a bicycle (not shown). However, unlike the prior art spindle 91 of FIG. 8, the spindle 2 of the present invention does not define an inner threaded hole in the end face thereof, but is formed in one piece and well retained in the axle hole 11 of the pedal body 1, without utilization of any bolt 92, as depicted in FIG. 8.

More specifically, as shown in FIG. 4, the insert portion 22 of the spindle 2 has a distal end 220 extending outside the first opening 13 of the pedal body 1. The first bushing 31 is mounted around the insert portion 22 of the spindle 2 and proximate to the first opening 13 of the pedal body 1. The second bushing 32 is also mounted around the insert portion 22 of the spindle 2, but proximate to the second opening 12 of the pedal body 1. In this illustrated embodiment, the first bushing 31 has a flange 310 abutting against an inwardly extending shoulder 130 of the first stepped opening 13. Similarly, the second bushing 32 has a flange 320 abutting against an inwardly extending shoulder 120 of the second stepped opening 12.

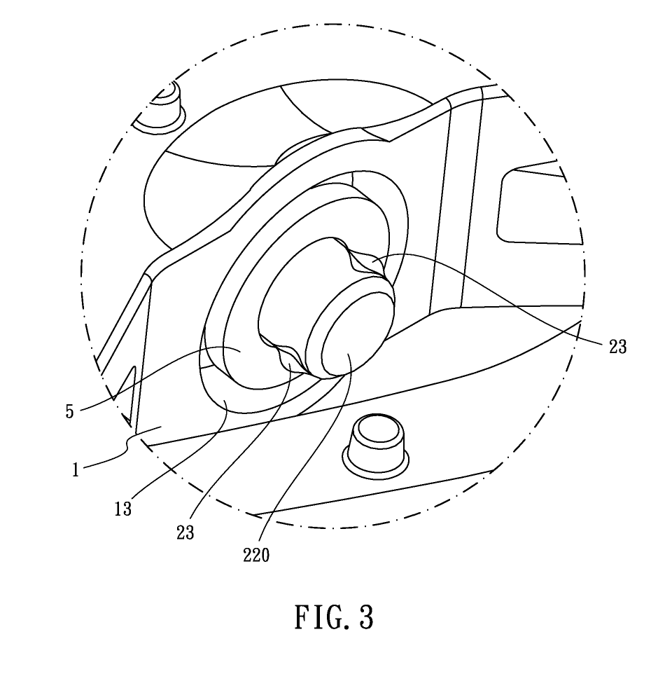

Furthermore, as best seen in FIG. 3, the distal end 220 of the insert portion 22 is shaped to include at least one raised bump 23 on a periphery thereof. As shown in FIG. 4, the washer 5 is mounted around the insert portion 22 of the spindle 2 and interposed in between the flange 310 of the first bushing 31 and the raised bump 23. The cap 4 is disposed at the first opening 13 of the pedal body 1 to enclose the distal end 220 of the spindle 2, the washer 5 and the flange 310 of the first bushing 31.

Moreover, as shown in FIG. 4, the distal end 220 of the insert portion 22 of the spindle 2 has a diameter extending through the raised bump 23 greater than an inner diameter of the first bushing 31 (and/or the washer 5 as in this embodiment) so as to retain the spindle 2 in position while the threaded portion 21 is engaged with the crane arm.

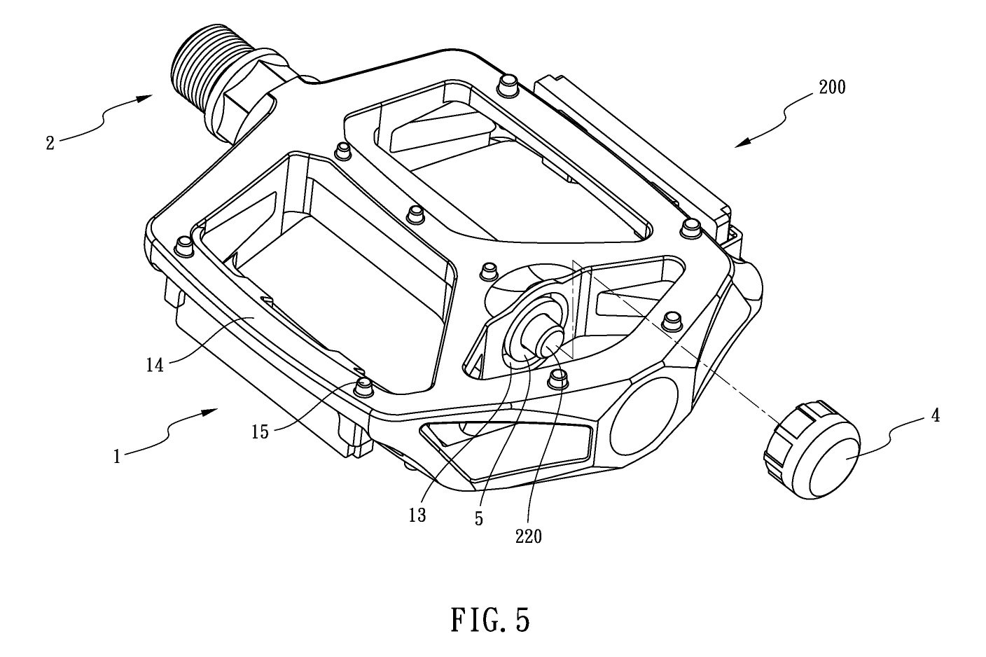

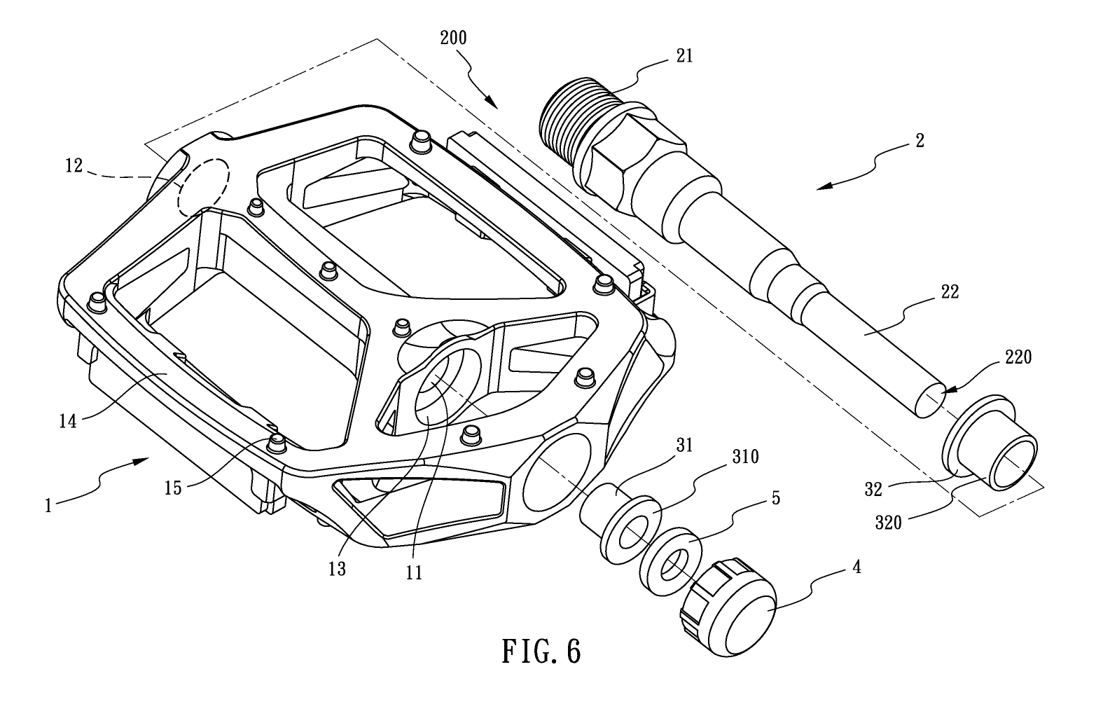

To produce the bicycle pedal 100, a raw, unfinished pedal 200 is provided, as shown in FIGS. 5 and 6. As shown, the raw pedal 200 includes components, such as the pedal body 1, the spindle 2, the first bushing 31, the second bushing 32, the washer 5 and the cap 4, as discussed above, except that the at least one raised bump 23 has not yet be formed on the distal end 220 of the insert portion 22 of the spindle 2. It is after the spindle 2 passes through the axle hole 11 of the pedal body 1, as shown in FIG. 5, that the at least one raised bump 23 can be formed by a machine tool. For example, a force is exerted on a peripheral of the distal end 220 of the insert portion 22 of the spindle 2 by means of the machine tool so as to at least partly deform the distal end 220 of the insert portion 22 and thereby create the raised bump 23 from the periphery of the distal end 220. In other words, the raised bump 23 of the distal end 220 is blocked outside the axle hole 11 of the pedal body 1, thereby retaining the spindle 2 in position. The pedal body 1 can therefore be well confined by the threaded portion 21 and the raised bump 23 of the spindle 2, and can rotate relative to the spindle 2, without falling off the spindle 2.

As described above, the present invention can be made in a relatively cost-effective manner, without the aid of a bolt and other processes associated in the prior art bicycle pedal.

What is claimed is:

1. A bicycle pedal, comprising:
a pedal body defining an axle hole therein with opposite first and second openings;
a spindle formed in one piece and having an insert portion generally passing through the axle hole of the pedal body, and a threaded portion extending outside the second opening of the pedal body for being secured to a crane arm of a bicycle; wherein the insert portion has a distal end extending outside the first opening and being shaped to include at least one raised bump on a periphery thereof; and
a first bushing mounted around the insert portion of the spindle and proximate to the first opening of the pedal body;
wherein the distal end of the insert portion of the spindle has a diameter extending through the raised bump greater than an inner diameter of the first bushing so as to retain the spindle in position when the threaded portion is engaged with the crane arm.

2. A bicycle pedal as recited in claim 1, further comprising a second bushing mounted around the insert portion of the spindle and proximate to the second opening of the pedal body.

3. A bicycle pedal as recited in claim 1, further comprising a washer mounted around the insert portion of the spindle and interposed in between the first bushing and the raised bump formed at the distal end of the insert portion.

4. A bicycle pedal as recited in claim 3, wherein the first opening of the pedal body is a stepped opening with an inwardly extending shoulder; the first bushing has a flange abutting against the inwardly extending shoulder of the first opening of the pedal body; and the washer is interposed between the flange of the first bushing and the raised bump of the spindle.

5. A bicycle pedal as recited in claim 4, further comprising a cap disposed at the first opening of the pedal body to enclose the distal end of the spindle, the washer and the flange of the first bushing
